(19) United States
(12) Patent Application Publication
(10) Pub. No.: US 2017/0159320 A1
(43) Pub. Date: Jun. 8, 2017

(54) Tent System and Method

(71) Applicant: Loni Bright, International Falls, MN (US)

(72) Inventor: Loni Bright, International Falls, MN (US)

(21) Appl. No.: 15/370,162

(22) Filed: Dec. 6, 2016

Related U.S. Application Data
(63) Continuation of application No. 62/263,782, filed on Dec. 7, 2015.

(51) Int. Cl. E04H 15/06; B64C 3/00; E04H 15/00; E04H 15/58; E04H 15/54; E04H 15/64

(52) U.S. Cl. CPC E04H 15/06; E04H 15/54; E04H 15/64; E04H 15/008; E04H 15/58; B64C 3/00

(57) ABSTRACT

A tent system and method includes a shell including at least one panel of material and having an opening therein through which an aircraft wing portion may be inserted, so that the shell easily pulls over the aircraft wing for support.

### FIELD OF THE DISCLOSURE

The invention relates generally to a tent system and method, and more particularly to a tent system and method for use with a winged aircraft.

### BACKGROUND

Pilots often fly small planes into remote areas where shelter or sleeping accommodations are unavailable. Typically, such pilots would need to pack a tent in their planes for such occasions. However, tents tend to be bulky, due in part to the fact that tent poles are required to set up the tent. In an airplane, both space and weight are at a premium. Thus, an additional or improved tent system and method for use with winged aircraft is desirable that is lightweight and packs into a relatively small space, without any required tent poles.

### SUMMARY

The present disclosure provides a tent system and method that includes a shell that easily pulls over an aircraft wing for support. When positioned over a wing, the shell forms an enclosure that may serve as a tent, ice fishing house, survival structure, etc. For convenience only, and without limitation, reference will be made herein only to a tent, even though other uses are possible.

Other benefits and advantages of the present disclosure will be appreciated from the following detailed description.

### DESCRIPTION OF THE DRAWINGS

FIG. 1 is a front perspective view of an exemplary embodiment of a tent system in use with a winged aircraft.

FIG. 2 is a rear perspective view of an exemplary embodiment of a tent system in use with a winged aircraft.

FIG. 3 is a side perspective view of an exemplary embodiment of a tent system in use with a winged aircraft.

FIG. 4 is a side perspective view, also showing the interior, of an exemplary embodiment of a tent system in use with a winged aircraft.

FIG. 5 is a cross-sectional view of an exemplary embodiment of a tent system in use with a winged aircraft.

FIG. 6A is a perspective view of an exemplary panel that forms the top and side walls of a tent system for use with a winged aircraft.

FIG. 6B is an elevation view from the rear of an exemplary panel that forms the rear wall of a tent system for use with a winged aircraft.

FIG. 6C is an elevation view from the front of an exemplary panel that forms the front wall of a tent system for use with a winged aircraft.

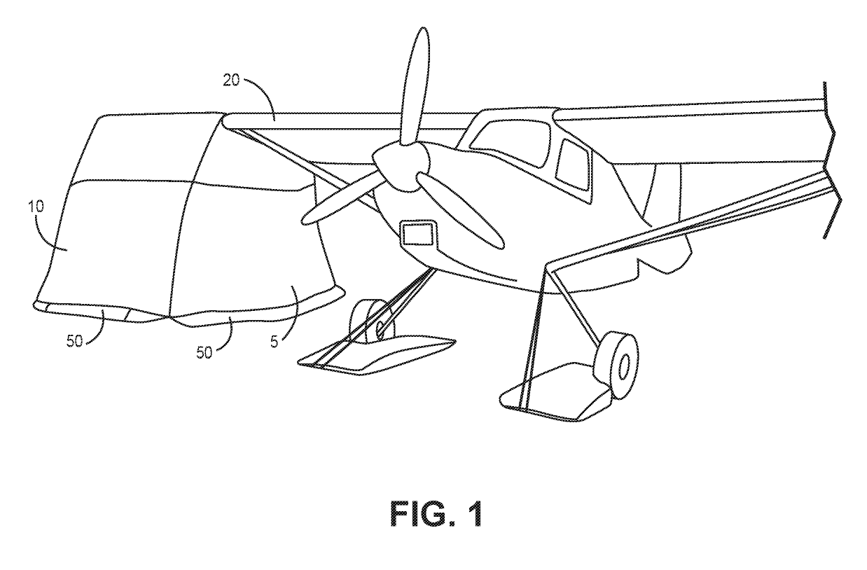

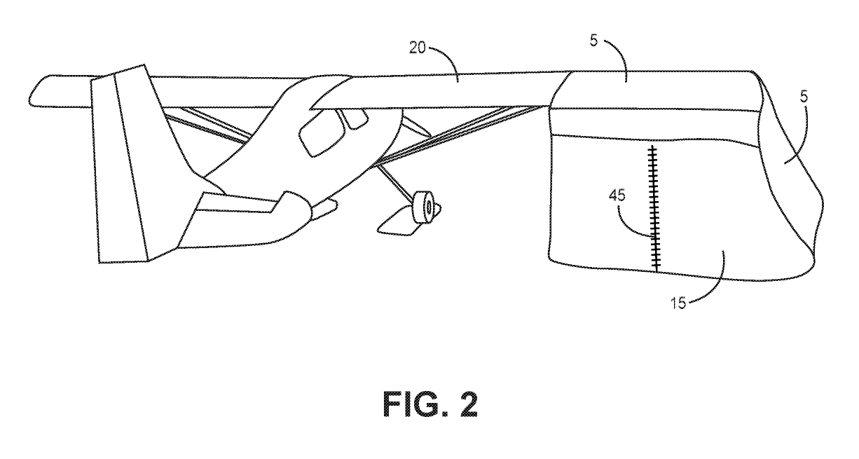

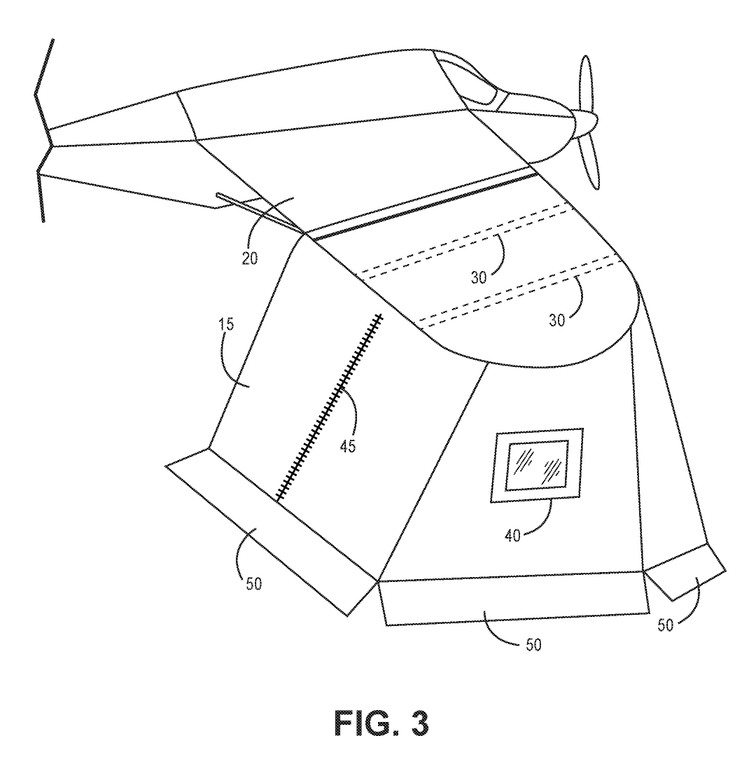

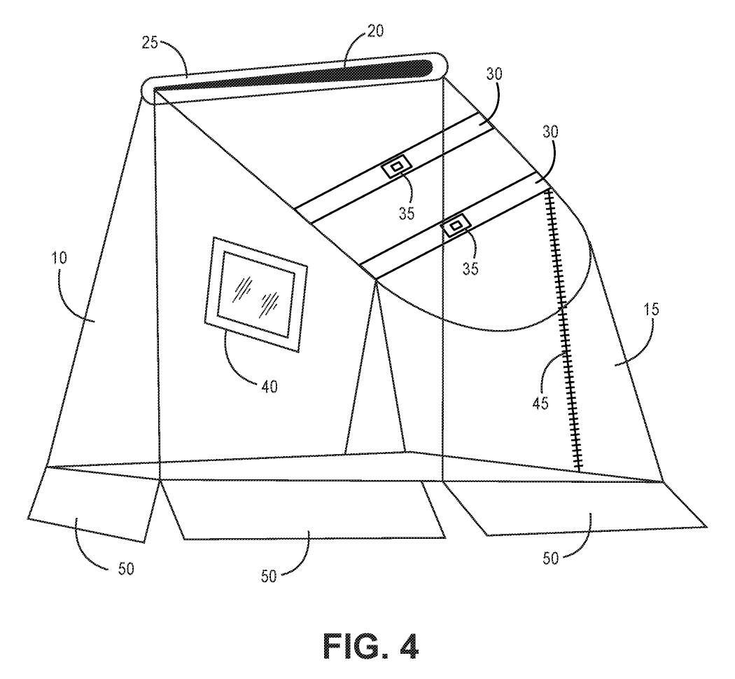

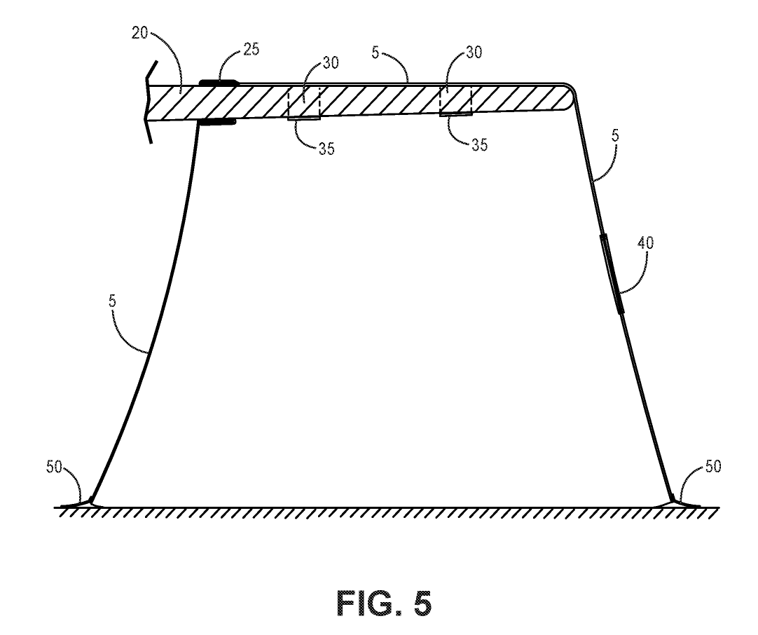

### DETAILED DESCRIPTION

Embodiments of the invention and various alternatives are described. Those skilled in the art will recognize, given the teachings herein, that numerous alternatives and equivalents exist which do not depart from the invention. It is therefore intended that the invention not be limited by the description set forth herein or below.

One or more specific embodiments of the system and method will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Further, for clarity and convenience only, and without limitation, the disclosure (including the drawings) sets forth exemplary representations of only certain aspects of events and/or circumstances related to this disclosure. Those skilled in the art will recognize, given the teachings herein, additional such aspects, events and/or circumstances related to this disclosure, e.g., additional elements of the devices described; events occurring related to tent set-up and take-down; etc. Such aspects related to this disclosure do not depart from the invention, and it is therefore intended that the invention not be limited by the certain aspects set forth of the events and circumstances related to this disclosure.

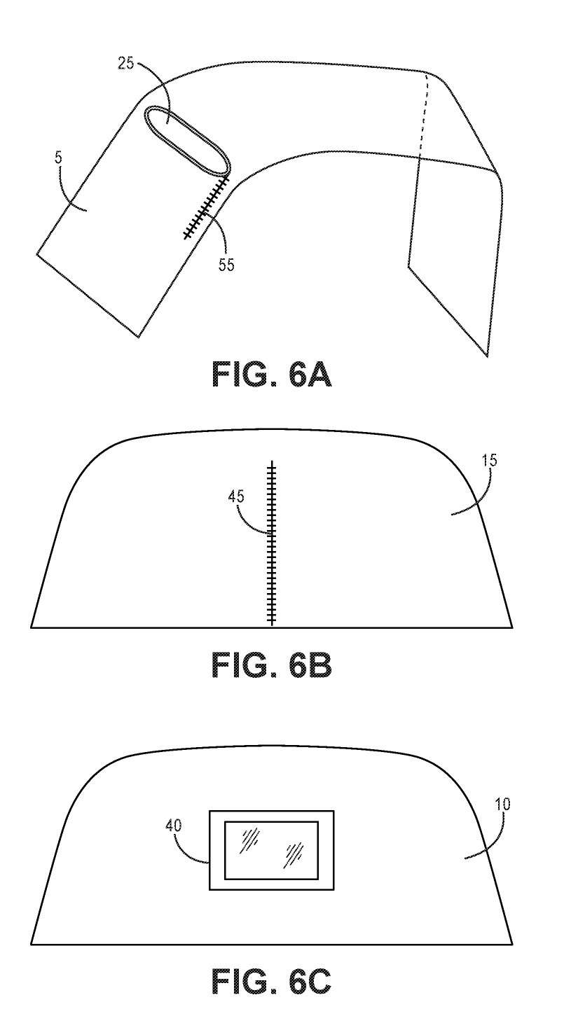

Turning now to the drawings, the figures show an exemplary tent system. The system includes one or more panels of material sewn or otherwise fastened together into a shell of desired shape. In one exemplary embodiment, the shell includes three or four panels of material. Of course the actual number of panels used will vary depending upon the circumstances involved in a particular application. An exemplary 3-panel tent system is shown by way of example only by joining together the panels described in FIGS. 6A, 6B, and 6C.

In an exemplary three-panel embodiment, a first panel 5 is adapted to fit over a wing 20. The first panel 5 incudes a hole 25 through which an aircraft wing may be inserted. About the hole is an elastic cord, advantageously included within a pocket formed of panel material about the circumference of the hole 25. In that way, once the wing 20 is inserted into the hole 25, the circumference of the hole 25 is held against the wing, e.g., to prevent the unwanted entrance of wind, rain, or snow into the tent through the hole 25. The first panel 5 also may be adapted with one or more straps 30 including releasable snaps or buckles 35, to help secure the first panel 5 to the wing 20 and help prevent unwanted movement of the tent relative to the wing 20. The first panel 5 may be of sufficient size and shape so when placed over a wing the first panel 5 forms the top and sidewalls of the tent system.

A second panel 10 may be secured to the first panel 5 at the forward or leading edge of first panel 5. The second panel 10 forms the front wall of the tent, and may include one or more features such as a window 40, door 45, vents, etc.

A third panel 15 may be secured to the first panel 5 at the rear or trailing edge of first panel 5. The third panel 15 forms the back wall of the tent, and also may include features such as windows, doors, vents, etc.

A wall including a door 45 may comprise a single panel with a zipper or other fastening means installed along a split in the panel. See, e.g., FIG. 6B. Alternately, the wall including a door may be formed of two panels joinable by a zipper or other fastening means.

In alternate embodiments, the system may include an additional panel that forms a tent floor. The additional panel may be secured about the periphery of the additional panel to portions of panel 5, panel 10, and panel 15.

In further embodiments, the tent system may include a zipper 55 in a panel, or between panels, that permits the tent system to be easily pulled over a wing including an air scoop. The zipper 55 is unzipped to expand the size of the hole 25 and thus permit the air scoop to pass through the expanded hole. The zipper 55 then is zipped shut to at least in part close the expanded hole, thus preventing the unwanted entrance of wind, rain, or snow into the tent through the expanded hole.

The panels forming the walls of the tent may include a flap 50 of material positionable along the ground. In one embodiment, stakes may be use to secure the flaps to the ground. In an alternate embodiment, the flaps extend away from the bottom of the tent so that snow, sand or other relatively heavy materials may be placed on the flaps to secure them against the ground. In this way, the unwanted entrance of wind, rain, or snow into the tent at the bottoms of the walls may be avoided.

Materials that may be used to construct the tent system may vary depending upon the particular circumstances involved. Examples of materials include nylon; rip-stop nylon; advanced polymer-based textiles that become thicker when cooled and thinner when heated; smart fabrics that power themselves and include thermoelectrics, batteries, and/or biofuel cells that harvest power from human sweat; etc. The materials in one embodiment are lightweight, thin, stretchable and flexible, and not bulky or heavy. However, canvas or other such materials also may be used under certain circumstances.

Tent accessories may be included to improve the user's experience. Items such as loops, pockets, LED lighting, solar-powered thermoelectrics for power, stuff sacks, screening, vestibules, etc. may be used. The system may be used with or without tent poles (e.g., shock corded poles), depending upon the circumstances involved in a particular application. In a simple embodiment, however, tent poles are not required, as an airplane wing provides needed support.

In one exemplary embodiment, a vestibule may be attached to a side of the shell, e.g., the rear of the tent that includes a door. The vestibule may take the form of a screened enclosure having screening on one or more sides of the vestibule. The vestibule may be adapted with windows, doors, etc. The vestibule may be supported with lines running between the tent and another object (e.g., the ground, a tree, etc.). Alternately, the vestibule may be supported with tent poles. Where a shell rear wall including a door may be pulled back and secured in an open position, a connecting vestibule may resemble a screened porch that expands the interior space of the tent system.

It should be understood that the foregoing description is only illustrative of the invention. Various alternatives and modifications can be devised by those skilled in the art having the benefit of this disclosure, without departing from the invention. Accordingly, the invention is intended to embrace all such alternatives, modifications and variances.

Certain exemplary embodiments of the disclosure may be described. Of course, the embodiments may be modified in form and content, and are not exhaustive, i.e., additional aspects of the disclosure, as well as additional embodiments, will be understood and may be set forth in view of the description herein. Further, while the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention.

What is claimed is:

1. A tent system without tent poles comprising a shell including a top, a front wall, a back wall, and two side walls opposite one another, the shell including:
a first panel of material including an opening therein shaped to fit over the wing of an aircraft, the first panel forming the top and the side walls of the shell and including a front peripheral edge opposite a rear peripheral edge,
a second panel of material including a first peripheral edge portion joined to the front peripheral edge of the first panel; and
a third panel of material including a second peripheral edge portion joined to the rear peripheral edge of the first panel.

2. The tent system of claim 1 including means positioned about the opening for securing an edge of the opening against a portion of an aircraft wing.

3. The tent system of claim 2, wherein the means includes an elastic cord.

4. The tent system of claim 1, wherein the opening includes an expanded hole formed by unzipping a zipper disposed in a wall of the shell adjacent to a hole disposed in the shell.

5. The tent system of claim 1, wherein one of the first panel of material, the second panel of material, and the third panel of material includes a door.

6. The tent system of claim 1, wherein one of the first panel of material, the second panel of material, and the third panel of material includes a window.

7. The tent system of claim 1, wherein the top includes means for securing the top to an aircraft wing.

8. The tent system of claim 7, wherein the means for securing comprises one or more releasable buckles.

9. The tent system of claim 1 including a bottom formed by a fourth panel of material including an outer periphery joined at least in part to the first panel, to the second panel, and to the third panel.

10. A tent system without tent poles comprising a shell including an opening therein, the opening formed so that a portion of an aircraft wing may be inserted therethrough to provide support for the shell, the shell at least partially defining an inner chamber suitable for camping use.

11. The tent system of claim 10 wherein the opening includes a hole formed in a panel of the shell.

12. The tent system of claim 11, wherein the opening includes an expanded hole formed adjacent the hole that shapes the opening to permit an aircraft air scoop to pass through the opening.

13. A method of forming a tent without using tent poles comprising providing a shell including an opening therein, the opening formed so that a portion of an aircraft wing inserted therethrough provides support for the shell, the shell forming an interior chamber suitable for camping use.

14. The method of claim 13 including the step of providing means for securing an edge of the opening against a portion of an aircraft wing inserted through the opening.

15. The method of claim 13 including providing a door in the shell.

16. The method of claim 13 including providing a window in the shell.

17. The method of claim 13 wherein the shell includes three panels of material.

18. The method of claim 13, wherein the shell includes four panels of material.
